(19) United States
(12) Patent Application Publication
(10) Pub. No.: US 2026/0218821 A1
(43) Pub. Date: Jul. 30, 2026

(54) FITTING DEVICE AND METHOD FOR PRODUCING A PIPE CONNECTION

(71) Applicant: Hackforth GmbH, Herne (DE)

(72) Inventors: Matthias THOME, Wegberg (DE); René HENKE, Herten (DE)

(73) Assignee: Hackforth GmbH, Herne (DE)

(21) Appl. No.: 19/572,904

(22) Filed: Mar. 20, 2026

Related U.S. Application Data
(63) Continuation of application No. PCT/EP2024/076641, filed on Sep. 23, 2024.

(30) Foreign Application Priority Data
Sep. 21, 2023 (DE) 10 2023 125 673.4

(51) Int. Cl. F16L 13/14; F16L 13/08

(52) U.S. Cl. CPC F16L 13/14; F16L 13/08; F16L 2013/145

(57) ABSTRACT

The disclosure relates to a fitting device (1) and a method for establishing a connection, for example a press-fit connection, between two pipe joint sections (2, 3). The problem addressed by the disclosure is that of allowing effective automation of establishing a connection between two pipe joint sections (2, 3). For this purpose, the disclosure proposes providing a manipulator (M) for moving a fitting tool (4), located on the manipulator (M), in space, wherein the fitting device (1) has at least one sensor (S) for detecting the position of at least one first pipe joint section (2) relative to the fitting device (1), wherein the fitting device (1) is designed to grasp the first pipe joint section (2), the position of which has been detected, by means of the fitting tool (4) and to align it with a second pipe joint section (3), wherein the fitting tool (4) is designed to connect the mutually aligned pipe joint sections (2, 3) with each other.

### CROSS REFERENCE TO RELATED APPLICATIONS

This application is a Continuation of PCT Patent Application No. PCT/EP2024/076641, having International filing date of Sep. 23, 2024, which claims the benefit of priority of German Patent Application No. 10 2023 125 673.4, filed on Sep. 21, 2023. The contents of the above applications are incorporated by reference as if fully set forth herein in their entirety.

### TECHNICAL FIELD

The disclosure relates to a fitting device for establishing a connection between two pipe joint sections. The disclosure also relates to a method for establishing a connection between two pipe joint sections, for example by means of such a fitting device.

### BACKGROUND

Fitting tools for assembling press-fit connections, that is solderless connections, for example for refrigeration technology and air conditioning technology (also known as “Lokring” connections), have been manufactured and distributed by the applicant for a long time. However, the fitting tools available to date, which are used to push a press sleeve onto the connection point between two pipe joint sections in order to establish the press-fit connection, are limited to manual fitting. The user of the fitting tool must first manually push the press sleeve over one of the pipe joint sections, that is position it manually, apply a sealant, and insert the pipe joint sections to be joined into each other apply the fitting tool by hand to the pipe joint sections to be joined and use it to push the press sleeve over the inserted into each other pipe joint sections. This deforms the pipe joint sections in the connection area and a fluid-tight and secure connection is established. For the final step, which requires force, the known fitting tools offer optional motorized support. This makes it relatively easy to connect pipe joint sections in refrigeration circuits to each other in a manual fitting process. A disadvantage of the known fitting tools is that sufficiently qualified personnel must always be available to assemble the press-fit connection. For this reason, the connection technology described herein has hardly been used in the production of large quantities of systems and devices (for example air conditioning systems, refrigerators) for cost reasons.

### SUMMARY

The disclosure provides a fitting device for establishing a connection between two pipe joint sections, with a manipulator for moving a fitting tool, located on the manipulator, in space, wherein the fitting device has at least one sensor for detecting the position of at least one first pipe joint section relative to the fitting device, wherein the fitting device is designed to grasp the first pipe joint section, the position of which has been detected, by means of the fitting tool and to align it with a second pipe joint section, wherein the fitting tool is designed to connect the mutually aligned pipe joint sections with each other.

### BRIEF DESCRIPTION OF THE DRAWINGS

Further features and details of the disclosure are apparent from the following description and the drawings, which show embodiments of the disclosure. Corresponding objects or elements are designated by the same reference numerals in all figures.

FIG. 1 shows a fitting tool of the fitting device according to the disclosure,

FIG. 2 shows a fitting tool with press sleeve being received,

FIG. 3 shows a fitting tool when receiving the first pipe joint section,

FIG. 4 shows a fitting tool when pushing the press sleeve onto the first pipe joint section,

FIG. 5 shows a fitting tool when receiving the second pipe joint section,

FIG. 6 shows a fitting tool when pushing the pipe joint sections into each other,

FIG. 7 shows a fitting tool after sliding the press sleeve onto the pipe joint sections,

FIG. 8 shows a fitting tool after establishing the press-fit connection,

FIG. 9 shows a fitting device with manipulator when detecting the position of the first pipe joint section,

FIG. 10 shows a fitting device when grasping the first pipe joint section,

FIG. 11 shows a fitting device when sliding the press sleeve onto the first pipe joint section,

FIG. 12 shows a fitting device when aligning the two pipe joint sections with each other,

FIG. 13 shows a fitting device when establishing the press-fit connection.

### DETAILED DESCRIPTION

The disclosure provides a fitting device for establishing a connection between two pipe joint sections, with a manipulator for moving a fitting tool, located on the manipulator, in space, wherein the fitting device has at least one sensor for detecting the position of at least one first pipe joint section relative to the fitting device, wherein the fitting device is designed to grasp the first pipe joint section, the position of which has been detected, by means of the fitting tool and to align it with a second pipe joint section, wherein the fitting tool is designed to connect the mutually aligned pipe joint sections with each other.

The disclosure provides also a method for establishing a connection between two pipe joint sections, for example by means of a fitting device of the type specified above, comprising the following steps:
Detecting the position of at least one first pipe joint section,
grasping and retaining the first pipe joint section detected in terms of position by means of a fitting tool arranged on a manipulator,
aligning the first pipe joint section held by the fitting tool with a second pipe joint section by movement using the manipulator, and
establishing a connection between the pipe joint sections by means of the fitting tool.

By means of the fitting device, the establishment of the connection can be easily and securely automatically be done. The manipulator, which may be, for example, a multi-axis articulated arm robot, but may also be a gantry robot, a delta robot, or the like, moves the fitting tool in space and automatically feeds the fitting tool so that it can perform the fitting steps necessary to establish the connection.

The manipulator can be for example designed to move the fitting tool, located on the manipulator, with at least two axes of movement. In other words, the manipulator has two or more degrees of freedom. This refers to the number of independent possibilities of movements which the manipulator can perform in space, more precisely, in its working space. Each degree of freedom represents an independent axis of movement along which or around which the manipulator can move. The degrees of freedom can be translational degrees of freedom. Each of which describes the movement along a straight axis. There are three translational degrees of freedom, which represent the movement along the x, y, and z axes in space. The degrees of freedom can also be rotational degrees of freedom. These describe the rotational movement around an axis. Here, too, there are basically three possible independent rotational movements around the x, y, and z axes. With three degrees of freedom, the manipulator can, for example, move the fitting tool independently along the x, y, and z axes, but cannot perform any rotations. With six degrees of freedom, the manipulator can move the fitting tool along the x, y, and z axes and additionally can rotate it around these axes. This enables free and complex movements and positioning in space. The more axes of movement or degrees of freedom the manipulator has, the more flexible and versatile it is in its movements. Four or five, for example at least six degrees of freedom offer a high degree of movement variety for the manipulator and can cover practically all fitting situations that occur.

The disclosure takes into account that the pipe joint sections (that is the pipe ends to be connected, for example made of copper pipe) may be positioned and oriented relative to each other in an undefined manner in space prior to the establishment of the connection. The fitting device determines with a sensor the position of the first pipe joint section in space and positions the fitting tool accordingly using the manipulator so that it can grasp and hold the pipe joint section. The fitting device then moves the grasped first pipe joint section in space, again using the manipulator, whereby the first pipe joint section is aligned with the second pipe joint section in a suitable manner (so that the connection can be made). In principle, the position of the second pipe joint section can also be detected by a sensor for this purpose. Similarly, its position in relation to the fitting device can be fixed. After the pipe joint sections have been aligned with each other, the fitting tool also grasps the second pipe joint section and holds it in place for the establishment of the connection. The first pipe joint section is a free pipe end. The other end of the same pipe will typically be fixed (for example to a component of a refrigeration machine). During the alignment of the pipe joint sections, that is the pipe ends with each other, the pipe or pipes are typically displaced. Finally, the pipe joint sections, which using the manipulator have been aligned with each other and correctly positioned, are automatically connected to each other using the fitting tool. The fitting device then releases the connected pipe joint sections.

Possible embodiments and optional further developments of the disclosure are set out in the dependent claims. It should be noted that the features listed individually in the claims can also be combined with each other in any technologically sensible manner, thus revealing further embodiments of the disclosure.

In one possible embodiment it is provided that the sensor is designed to detect the position of the first pipe joint section in three dimensions in order to cover all conceivable fitting situations. Thereby, the fitting device is designed to grasp the pipe joint sections using the fitting tool in accordance with the three-dimensional coordinates detected and to align them with each other.

According to one possible embodiment it is provided that the at least one sensor is an optical sensor. The optical sensor can be an optical proximity switch consisting of a light emitter, for example a light-emitting diode or a laser diode, and a light receiver, for example a light-dependent resistor (LDR) or a photodiode. The light receiver of the optical sensor can also be designed as a camera that detects light emitted by the light emitter in order to determine the exact position of the pipe joint section in the fitting space of the fitting device, that is in the space accessible by the manipulator.

The connection produced according to the disclosure may be, for example, a press-fit connection or a soldered connection, or another type of connection technology for pipes known as such. The press-fit connection may be, for example, the known connection using a press sleeve (for example Lokring), but a radial press-fit connection without a press sleeve is also conceivable, as is a connection by (for example inductive) soldering, in which case the fitting device is then suitably designed to feed solder to the connection point and to heat the connection point to liquefy the solder. It is also conceivable that the pipe joint sections are connected with (conventionally known) fittings (for example Connex, Parker) or quick couplings, in which case the fitting device according to the disclosure is then designed to establish the connection by means of such elements.

In one possible embodiment it is provided that the fitting device has a magazine for press sleeves for establishing the press-fit connection, whereby the manipulator is designed to load the fitting tool with press sleeves from the magazine. The magazine can be used to automatically supply the required number of press sleeves to the fitting space of the fitting device. The manipulator can easily pick up the press sleeves provided by the magazine via the fitting tool. The fitting device thus automatically supplies itself with the required press sleeves. These only need to be kept in the magazine within reach of the device.

One possible embodiment relates to the fact that the fitting tool comprises at least: a first retaining element for receiving the first pipe joint section, a second retaining element for receiving the second pipe joint section, which is at least partially expanded relative to the first pipe joint section or has a larger overall diameter, a guide via which the two retaining elements are guided so that they can be moved relative to each other, and a sliding element for sliding a press sleeve onto the pipe joint sections, pushed into each other and being held by the retaining elements, wherein the sliding element is designed to slide the press sleeve onto the pipe joint sections in the axial direction by means of automatic displacement, wherein the retaining elements via the guide are designed to push pipe joint sections, held in the retaining elements and aligned coaxially with each other, into each other in the axial direction by means of automatic displacement, wherein the sliding element is designed to hold the press sleeve, wherein the sliding element is further designed to slide a being held press sleeve in a first axial direction onto the first pipe joint section and furthermore to push the press sleeve onto the pushed-together pipe joint sections in a second axial direction opposite to the first axial direction. “At least partially expanded” can mean that either one of the pipe ends to be connected is only expanded in sections, that is at least in the connection area, so that it can accommodate the other pipe end there. It also means that one of the pipe ends has a correspondingly larger width (that is inner diameter) overall compared to the other pipe end. In other words, two pipe joint sections are connected to each other whose outer and inner diameters (at least in the connection area) are matched so that they can be inserted into each other.

The first pipe joint section can be easily grasped by the fitting tool in the fitting space of the fitting device via the first retaining element. The guide of the fitting tool shifts the two retaining elements relative to each other in such a way that the first pipe joint section is pushed at least partially into the second pipe joint section. The sliding element for sliding the press sleeve onto the pipe joint sections held together by the retaining elements is automatically moved relative to the two retaining elements of the fitting tool. This allows the press sleeve received in the sliding element to be pushed onto the pipe joint sections in the axial direction to establish the connection.

One possible embodiment of the disclosure provides for a metering device on the fitting tool for applying a sealing compound to at least one of the pipe joint sections. The automatic application of the sealant ensures excellent sealing of the gap between the pipe joint sections to be joined. The sealant automatically applied by the metering device of the fitting device penetrates, for example, by capillary action into the gap between the pipe joint sections held by the retaining elements and inserted into one another. Alternatively, the sealant can be applied to one of the pipe joint sections, for example to the innermost, first pipe joint section, before they are inserted into each other.

An optional embodiment provides for the fitting device to comprise an expander which is designed to expand one of the pipe joint sections at least in sections. With the expander, the fitting device can automatically expand a pipe joint section at least in sections and prepare it for the press-fit connection. The other pipe joint section can be easily inserted into the section expanded by the expander.

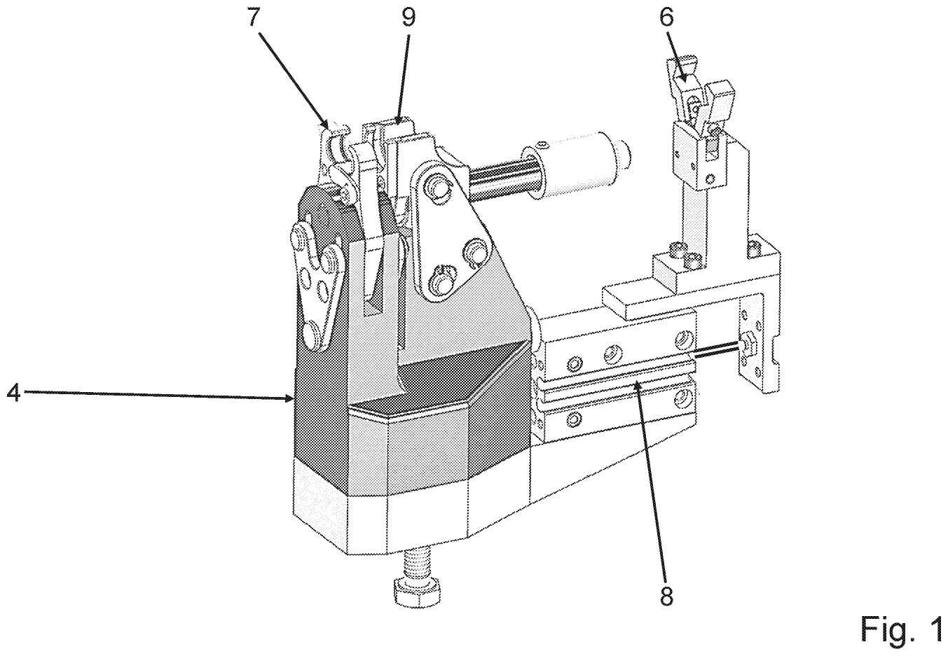

FIG. 1 shows a fitting tool 4 of a fitting device 1 according to the disclosure, designated by reference numeral 4. The fitting tool 4 is used for the automatic fitting of a press-fit connection, for example a Lokring connection. Via the press-fit connection two pipe joint sections 2, 3 of a refrigeration circuit can be easily connected to each other.

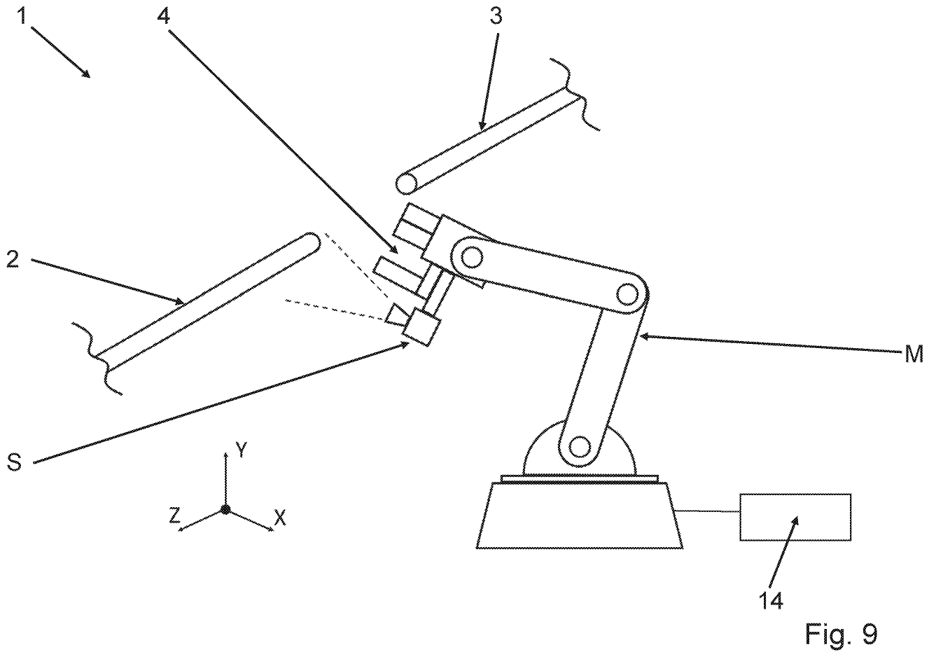

The fitting device 1 has a multi-axis articulated arm robot as manipulator M for manipulation of the fitting tool 4, located on the manipulator, of the fitting device 1, that is for moving the fitting tool 4 (shown only very schematically in FIGS. 9 to 13) in space. The manipulator M is designed to move the fitting tool 4 into any position and orientation in space. The design of the manipulator as a multi-axis articulated arm robot allows a movement with three or more (for example six) degrees of freedom. Three-dimensional translational and rotational mobility of the fitting tool 4 is a possible feature. Depending on the design of the manipulator M, fewer degrees of freedom may also be provided. For example, due to the axial symmetry of the pipe joints, a degree of rotational freedom around the pipe axis may be dispensed with if necessary. The fitting device 1 has at least one sensor S. The sensor S is used to detect the spatial (three-dimensional) position of at least one pipe joint section 2, 3 relatively to the fitting device 1 (FIG. 9). The alignment, that is the spatial orientation of the longitudinal axis of the at least one pipe joint section 2, 3, can also be for example detected by means of the sensor S. The sensor S is connected to a control device 14 (FIGS. 9 to 13) in order to process the detected position data and to control the movement of the manipulator M on this basis.

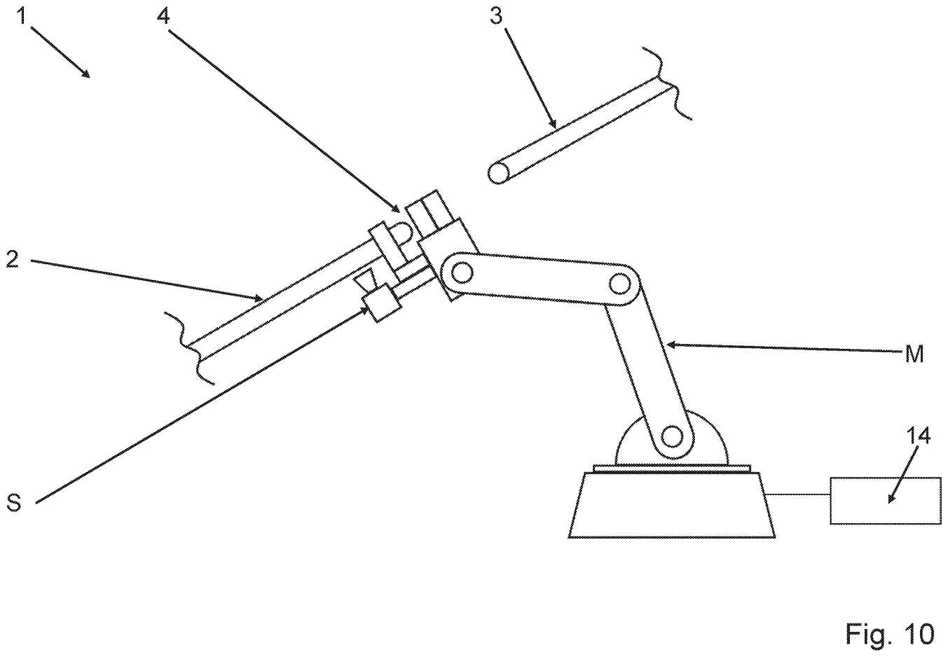

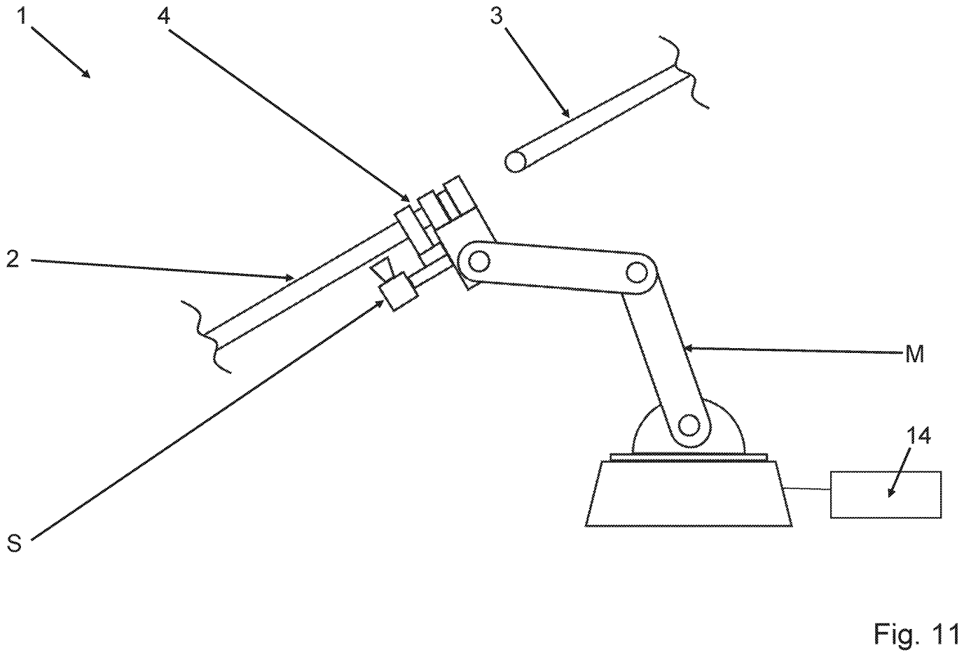

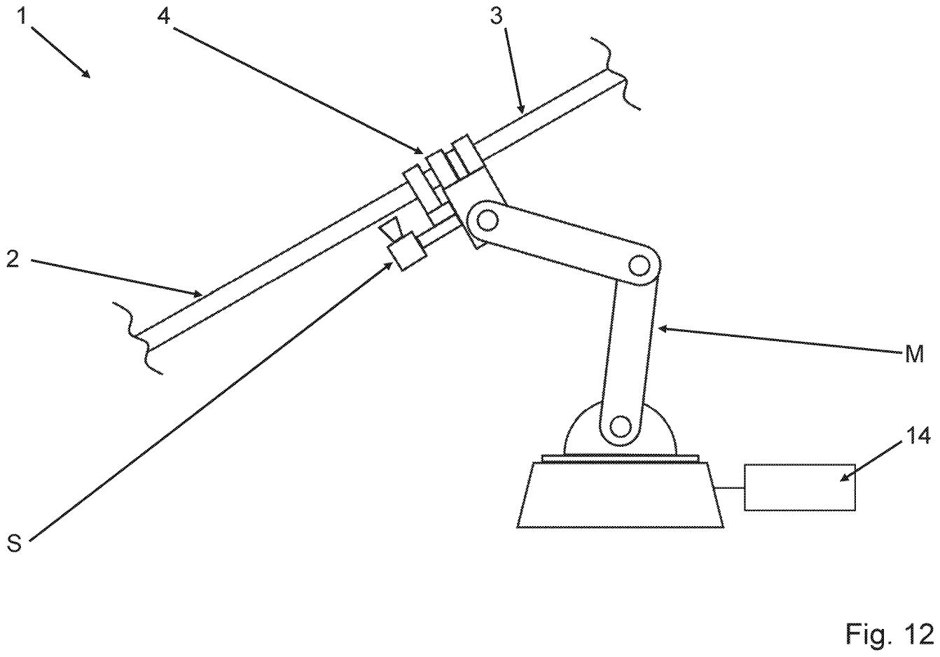

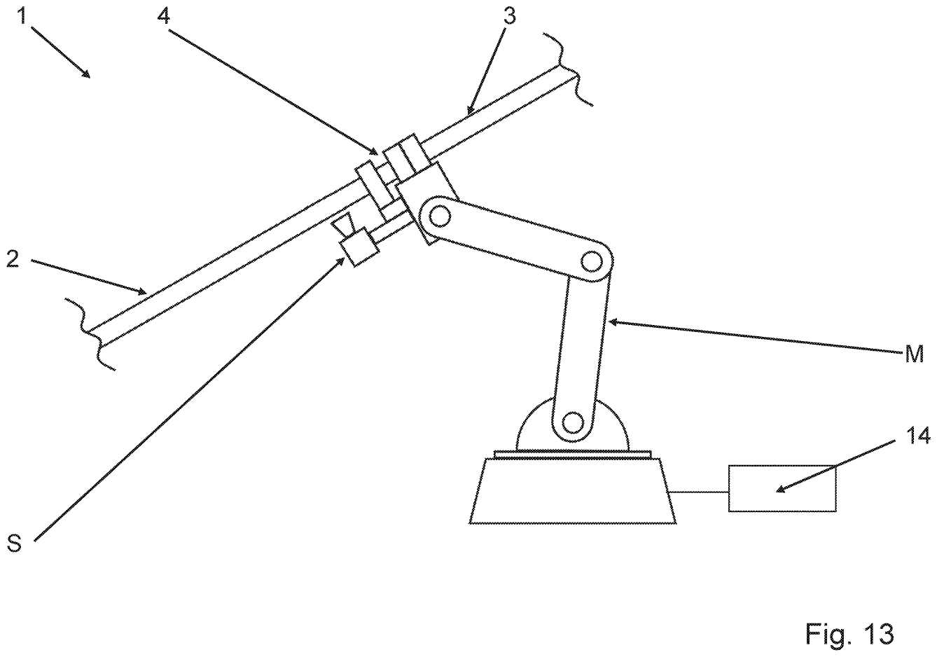

The manipulator M is also designed to grasp the first pipe joint section 2, which has been detected in terms of its position (and orientation), with the fitting tool 4 (FIG. 10) and to align it coaxially with the second pipe joint section 3, whose position (and orientation) in space relative to the fitting device 1 is either fixed predetermined or is also detected by the sensor S of the fitting device 1. A press sleeve (not shown in FIGS. 9 to 13) is first pushed onto the grasped end of the pipe joint section 3 using the fitting tool 4 (FIG. 11). Then, the two pipe joint sections 2, 3 are aligned coaxially with each other using the manipulator M (FIG. 12). In doing so, the grasped pipe joint section 2 is displaced spatially. In addition, the fitting tool 4 is designed to connect the pipe joint sections 2, 3, which are moved using the manipulator M toward each other and aligned with each other, into a press-fit connection (FIG. 13), for which purpose the press sleeve previously pushed onto the pipe joint section 2 is pushed over the connection point of the two pipe joint sections 2, 3.

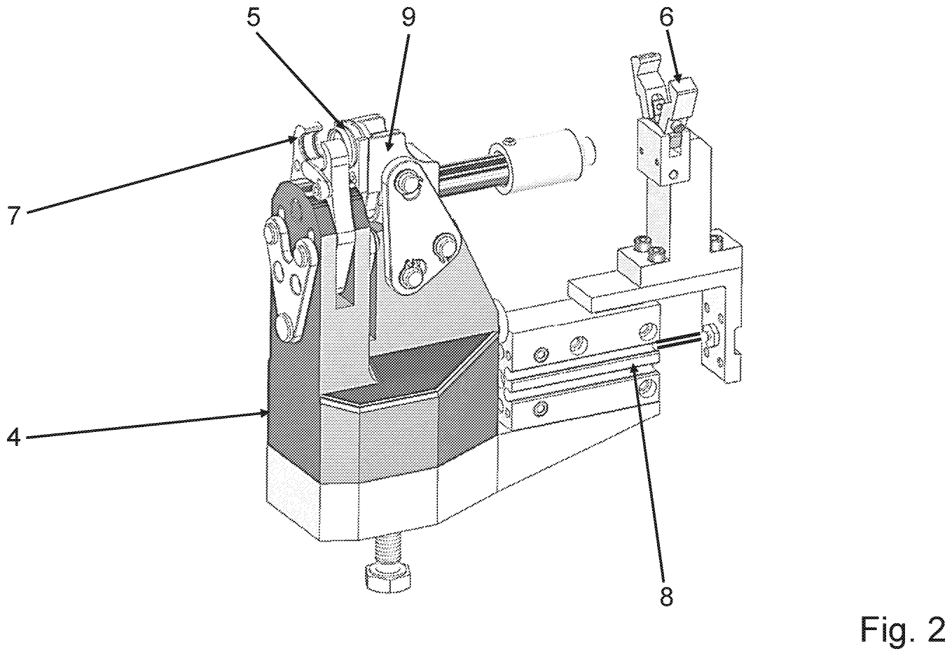

The FIGS. 2 to 8 described below are intended to explain in more detail the automated establishment of the press-fit connection using the fitting tool 4. In principle, the fitting tool 4 shown can also be used independently of the manipulator M, that is as a hand-held tool. However, the following explanation refers to the fitting tool 4 shown in the figures being arranged on the manipulator M (as shown in FIGS. 9 to 13).

The FIG. 2 shows the fitting tool 4 according to FIG. 1 after receiving the press sleeve 5. The press sleeve 5 is received and held by a sliding element 9 of the fitting tool 4. The sliding element 9 is designed for this as a gripper, for example with retaining jaws. The fitting device 1 may comprise a magazine for press sleeves 5, which is not shown, from which the fitting tool 4 with the sliding element 9 removes the press sleeves 5 guided by the manipulator M.

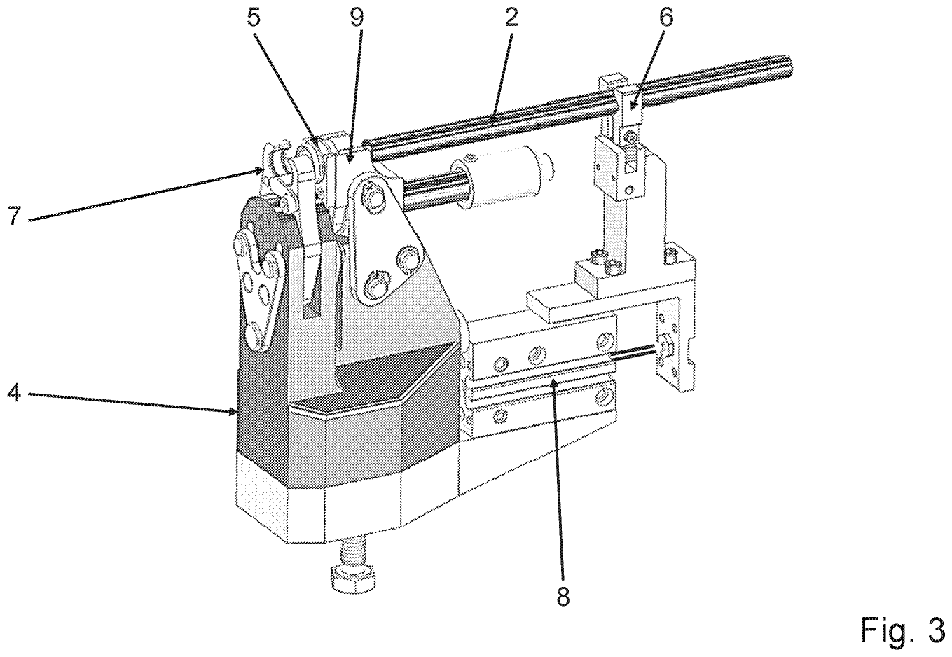

FIG. 3 shows how the fitting tool 4 receives, that is grasps, the first pipe joint section 2 (corresponding to FIG. 10). For this purpose, the fitting tool 4 comprises a first retaining element 6 for receiving the first pipe joint section 2. The first retaining element 6 is for example designed as a gripper, for example with retaining jaws. The fitting tool 4 with the first retaining element 6 is positioned by the manipulator M so that the first retaining element 6 can grip the first pipe joint section 2 at the detected position, as shown in FIG. 3.

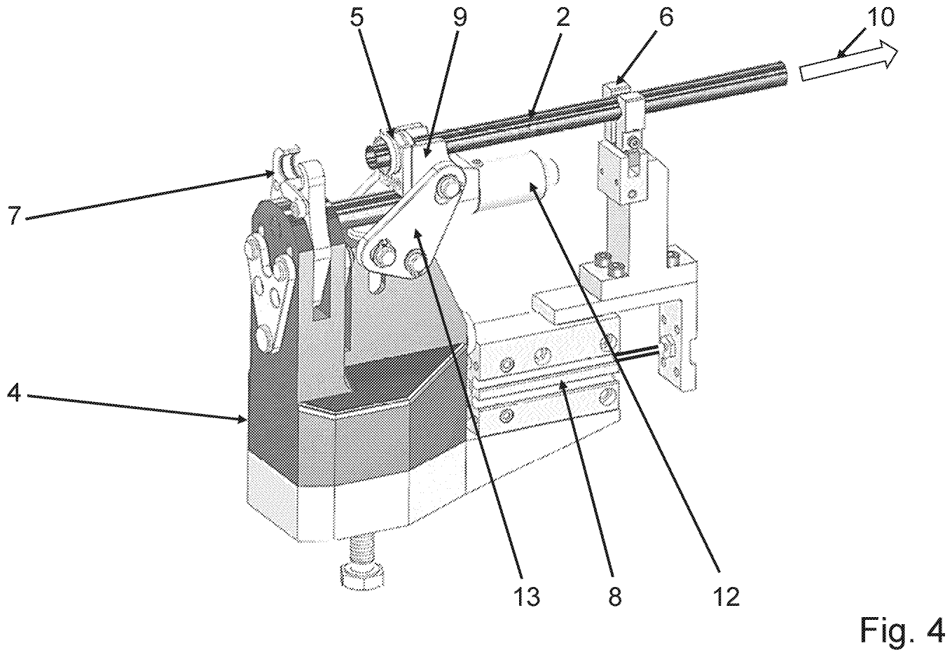

The FIG. 4 shows the fitting tool 4 when pushing the press sleeve 5 onto the first pipe joint section 2 (corresponding to FIG. 11). To do this, the sliding element 9 is moved relative to the first retaining element 6 so that the being held press sleeve 5 is pushed onto the first pipe joint section 2 in a first axial direction 10. An adjustable sleeve 12 serves as an end stop for the sliding element 9. This is driven by a pneumatic or hydraulic linear drive (not shown) via a lever arm 13. This can be used to generate sufficient sliding force to establish the press-fit connection.

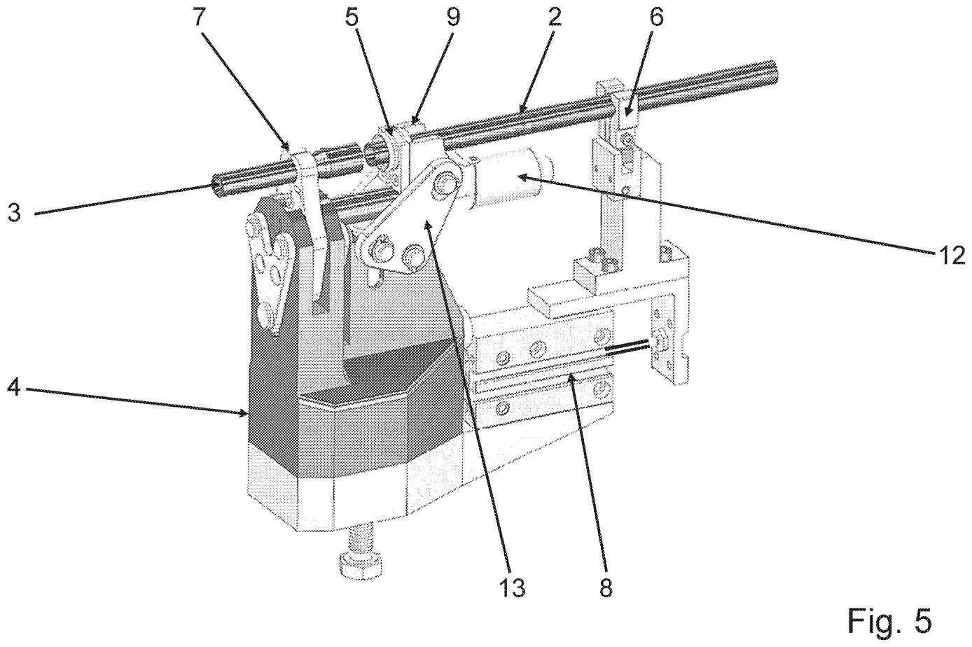

FIG. 5 shows how the fitting tool 4 receives the second pipe joint section 3. For this purpose, the fitting tool 4 has a second retaining element 7. The second retaining element 7 is for example also designed as a gripper, for example with clamping jaws, which are designed to absorb the forces during the establishment of the press-fit connection (more details on this immediately). The second pipe joint section 3 is expanded at least in sections. For this purpose, the fitting tool 4 may comprise an expander (not shown). The second pipe joint section 3 can thus be expanded in sections before or during being received into the second retaining element 7 of the fitting tool 4. With the taken-up of the second pipe joint section 3 into the second retaining element 7, the pipe joint sections 2, 3 are positioned coaxially with each other in the retaining elements 6, 7 of the fitting tool 4 (corresponding to FIG. 12). The fitting tool 4 also has a guide 8, via which the retaining element 6 is guided so that it can be moved towards the retaining element 7. For this purpose, the guide 8 can interact with a suitable linear drive (for example pneumatic or hydraulic).

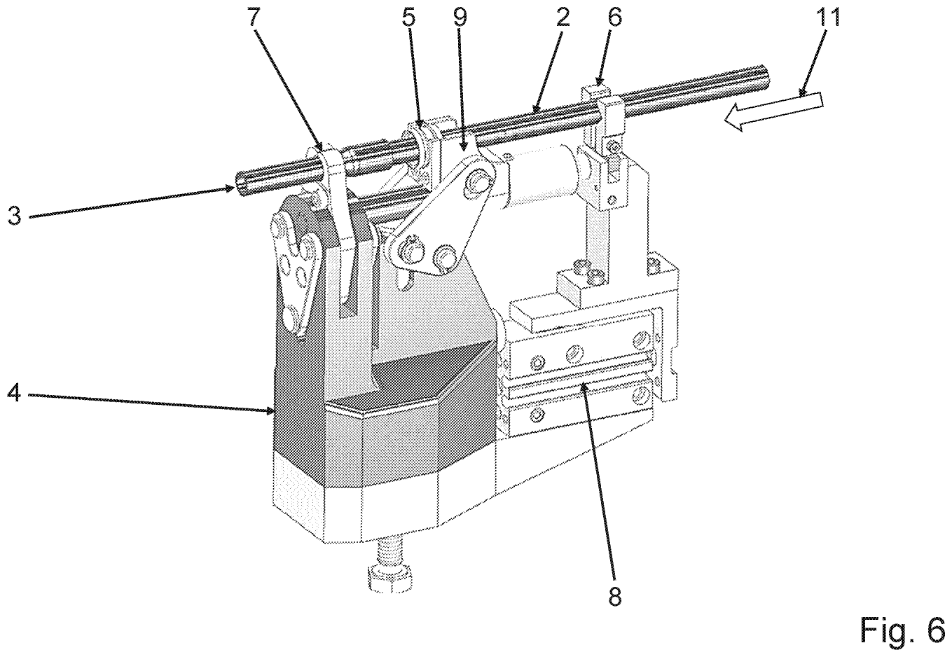

FIG. 6 shows the fitting tool 4 when pushing the pipe joint sections 2, 3 into each other. For this purpose, the first pipe joint section 2 is pushed into the second pipe joint section 3. This is done by automatically moving the retaining element 6 toward the retaining element 7 along the guide 8 of the fitting tool 4 in the axial direction 11.

A metering device not shown for applying a sealing agent to the pipe joint sections 2, 3 may be provided on the fitting tool 4. The automatic application of the sealing agent ensures excellent sealing of the gap between the pipe joint sections 2, 3. The sealing agent automatically applied to the pipe joint section 2 by the metering device of the fitting device 1 penetrates the gap between the pipe joint sections 2, 3, held together by the retaining elements 6, 7, through capillary action.

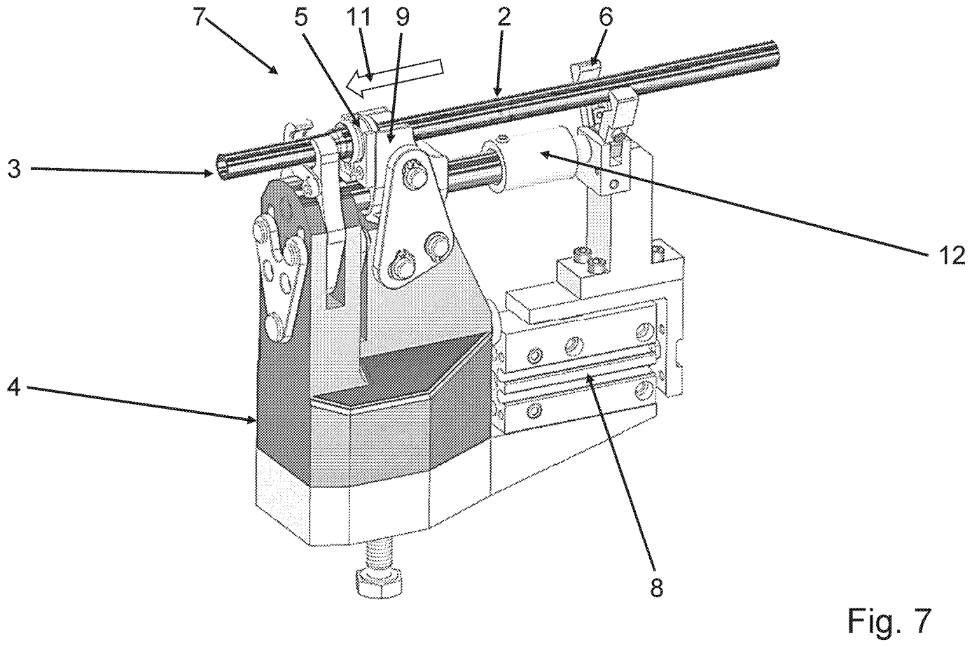

The fitting tool 4 pushes the press sleeve 5 onto the pipe joint sections 2, 3. To do this, the sliding element 9 moves the press sleeve 5 onto the pipe joint sections 2, 3, being held pushed into each other by the retaining elements 6, 7. The sliding element 9 thus automatically slides the press sleeve 5 onto the pipe joint sections 2, 3 and namely in axial direction 11. This second axial direction 11 is hereby opposite to the first axial direction 10 (FIG. 4). The forces acting hereby are absorbed by the retaining element 7, in which the pipe joint section 3 is held in a clamped position. The FIG. 7 shows the state after the press sleeve 5 has been pushed on in the manner described. The clamping jaws of the retaining element 7 are then opened, as they no longer need to hold the pipe joint section 3, which is now firmly connected to the pipe joint section 2.

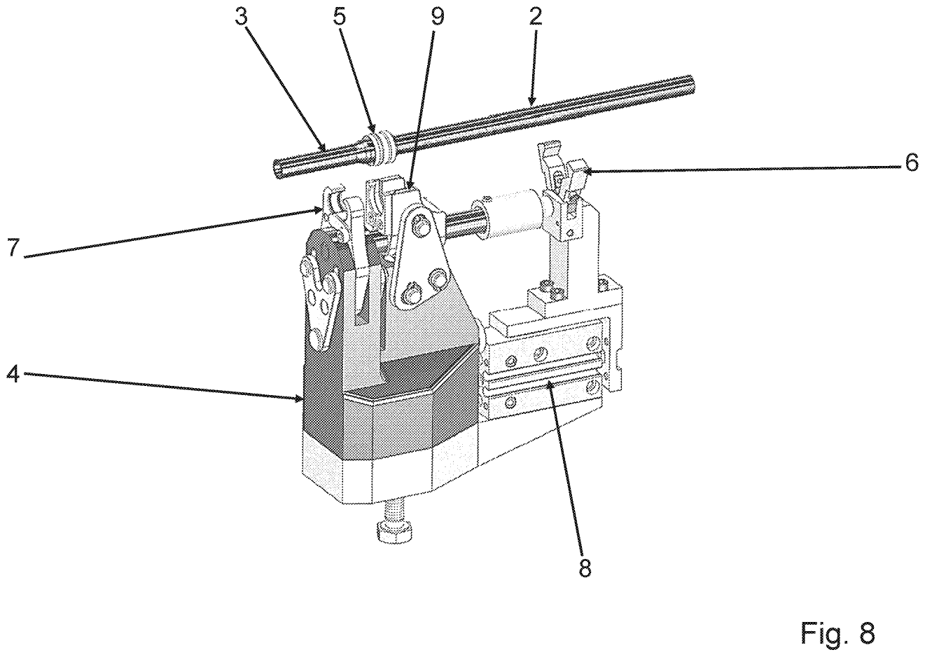

Finally, the fitting tool 4 is removed from the press-fit connection established, as shown in FIG. 8 (by means of the manipulator M). For this purpose, the retaining element 6 also releases the connected pipe joint sections 2, 3, and the sliding element 9 releases the pushed-on press sleeve 5.

The disclosure provides for a fitting device and a method that enables effective automation when establishing a press-fit connection between two pipe joint sections to be joined.

### LIST OF REFERENCE SYMBOLS

1 fitting device
2 first pipe joint section
3 second pipe joint section
4 fitting tool
5 press sleeve
6 first retaining element
7 second retaining element
8 guide
9 sliding element
10 first axial direction
11 second axial direction
12 sleeve
13 lever arm
14 control device
M manipulator
S sensor

1. Fitting device (1) for establishing a connection between two pipe joint sections (2, 3), with a manipulator (M) for moving a fitting tool (4), located on the manipulator (M), of the fitting device (1) in space, wherein the fitting device (1) has at least one sensor (S) for detecting the position of at least one first pipe joint section (2) relative to the fitting device (1), wherein the fitting device (1) is designed to grasp the first pipe joint section (2), the position of which has been detected, by means of the fitting tool (4) and to align it with a second pipe joint section (3), wherein the fitting tool (4) is designed to connect the mutually aligned pipe joint sections (2, 3) with each other.

2. Fitting device (1) according to claim 1, characterized in that the manipulator (M) is designed to move the fitting tool (1), located on the manipulator (M), with at least two axes of movement.

3. Fitting device (1) according to claim 1, characterized in that the sensor (S) is designed for three-dimensional detection of the position of the first pipe joint section (2) in space.

4. Fitting device (1) according to claim 1, wherein the sensor (S) is an optical sensor.

5. Fitting device (1) according to claim 3, wherein the sensor (S) is designed to detect three-dimensional coordinates of at least one pipe joint section (2, 3) relative to the fitting device (1), wherein the fitting device (1) is designed to grasp the pipe joint sections (2, 3) by means of the fitting tool (4) in accordance with the detected three-dimensional coordinates and to align them with one another.

6. Fitting device (1) according to claim 1, wherein the fitting tool (4) is designed to connect the with each other aligned pipe joint sections (2, 3) by means of a press-fit connection or a solder connection.

7. Fitting device (1) according to claim 6, wherein the fitting device (1) has a magazine for press sleeves (5) for establishing the press-fit connection, wherein the manipulator (M) is designed to load the fitting tool (4) with press sleeves (5) from the magazine.

8. Fitting device (1) according to claim 6, wherein the fitting tool (4) comprises at least: a first retaining element (6) for receiving the first pipe joint section (2), a second retaining element (7) for receiving the second pipe joint section (3), which is at least partially expanded relative to the first pipe joint section (2) or has a larger overall diameter, a guide (8) via which at least one of the two retaining elements (6, 7) is guided in a manner that allows it to be displaced relative to the other retaining element (6, 7), and a sliding element (9) for sliding a press sleeve (5) onto the pipe joint sections (2, 3), pushed into each other and being held by the retaining elements (6, 7), wherein the sliding element (9) is designed to slide the press sleeve (5) onto the pipe joint sections (2, 3) in the axial direction (10, 11) by means of automatic displacement, wherein the retaining elements (6, 7) via the guide (8) are designed to push the pipe joint sections (2, 3), held in the retaining elements (6, 7) and aligned coaxially with each other, into each other in the axial direction (10, 11) by means of automatic displacement relative to each other, wherein the sliding element (9) is designed to hold the press sleeve (5), wherein the sliding element (9) is designed to slide the press sleeve (5) in a first axial direction (10) onto the first pipe joint section (2) and is further adapted to slide the press sleeve (5) onto the pushed-together pipe joint sections (2, 3) in a second axial direction (11) opposite to the first axial direction (10).

9. Fitting device (1) according to claim 8, wherein a metering device for applying a sealing agent to at least one of the pipe joint sections (2, 3) is provided on the fitting tool (4).

10. Fitting device (1) according to claim 1, wherein the fitting device (1) comprises an expander which is designed to expand one of the pipe joint sections (2, 3) at least in sections.

11. Fitting tool (4), for example for a fitting device (1) according to claim 1, wherein the fitting tool (4) comprises at least:
a first retaining element (6) designed to receive a first pipe joint section (2),
a second retaining element (7) designed to receive a second pipe joint section (3),
a guide (8) via which at least one of the two retaining elements (6, 7) is guided so that it can be displaced relative to the other retaining element (6, 7), and
a sliding element (9) designed to slide a press sleeve (5) onto the pipe joint sections (2, 3) being held pushed into each other by the retaining elements (6, 7), wherein the sliding element (9) is designed to slide the press sleeve (5) onto the pipe joint sections (2, 3) in the axial direction (10, 11) by means of automatic displacement, wherein the retaining elements (6, 7) are designed via the guide (8) to push the pipe joint sections (2, 3), received in the retaining elements (6, 7) and aligned coaxially with each other, into each other in axial direction (10, 11) by means of automatic displacement relative to each other, wherein the sliding element (9) is designed to hold the press sleeve (5), wherein the sliding element (9) is designed to slide the press sleeve (5) in a first axial direction (10) onto the first pipe joint section (2) and is further adapted to slide the press sleeve (5) onto the pushed-together pipe joint sections (2, 3) in a second axial direction (11) opposite to the first axial direction (10).

12. Method for establishing a connection between two pipe joint sections (2, 3), for example by means of a fitting device (1) according to claim 1, comprising the following steps:
Detecting the position of at least one first pipe joint section (2),
grasping and retaining the first pipe joint section (2) detected in terms of position by means of a fitting tool (4) arranged on a manipulator (M),
aligning the first pipe joint section (2) held by the fitting tool (4) with a second pipe joint section (3) by movement using the manipulator (M), and
establishing a connection between the pipe joint sections (2, 3) by means of the fitting tool (4).

13. Method according to claim 12, wherein the connection is a press-fit connection or a soldered connection.

14. Method according to claim 13, wherein the production of the press-fit connection comprises the following steps:
Retaining the first pipe joint section (2, 3) in a first retaining element (6) of the fitting tool (4),
providing a press sleeve (5) in a sliding element (9) of the fitting tool (4),
sliding the press sleeve (5) onto the first pipe joint section (2) in a first axial direction (10) by means of the sliding element (9),
receiving the second pipe joint section (3), which is at least partially expanded relative to the first pipe joint section (2), in a second retaining element (7) of the fitting tool (4) and coaxially aligning the pipe joint sections (2, 3) with each other in the retaining elements (6, 7),
inserting the first pipe joint section (2) into the second pipe joint section (3) by means of automatic displacement of at least one of the retaining elements (6, 7) along a guide (8) of the fitting tool (4) in the axial direction (10, 11),
sliding the press sleeve (5) onto the pushed-together pipe joint sections (2, 3) by means of automatic displacement of the sliding element (9) in a second axial direction (11) opposite to the first axial direction (10), and
removing the fitting tool (4) from the established press-fit connection.

15. Method according to claim 14, wherein a sealing agent is applied to at least one of the pipe joint sections (2, 3) by means of a metering device of the fitting device (1).

16. Method according to claim 14, wherein the second pipe joint section (3) is expanded before or during being received into the second retaining element (7) of the fitting tool (4).

17. Method according to claim 12, wherein the alignment of the first pipe joint section (2) held by the fitting tool (4) with the second pipe joint section (3) is carried out by a movement by means of the manipulator (M) with two or more, for example at least three, further for example at least six degrees of freedom of movement.
